(19) United States
(12) Patent Application Publication
(10) Pub. No.: US 2025/0030263 A1
(43) Pub. Date: Jan. 23, 2025

(54) DEVICE FOR REGULATING A CHARGING CURRENT FOR A BATTERY AND BATTERY MANAGEMENT SYSTEM COMPRISING SUCH DEVICE

(71) Applicant: LIMATECH, Toulouse (FR)

(72) Inventors: Luc Pouyadou, Toulouse (FR); Florence Robin, Toulouse (FR); Maxime Di Meglio, Toulouse (FR)

(21) Appl. No.: 18/774,546

(22) Filed: Jul. 16, 2024

(30) Foreign Application Priority Data
Jul. 17, 2023 (FR) FR2307648

(51) Int. Cl. H02J 7/00; H01M 10/42

(52) U.S. Cl. CPC H02J 7/007192; H01M 10/425; H02J 7/0031; H01M 2010/4271

(57) ABSTRACT

The invention relates to a device to regulate a charge current for a battery, said device being a quadrupole configured to link a battery to a charging device, said device comprising at least a first transistor (M₁), said charge transistor, and a thermistor (R₁), which are configured to regulate, in association, the charge current of the battery according to the temperature.

### CROSS-REFERENCE TO RELATED APPLICATIONS

This application claims priority to French Application No. FR2307648, filed on Jul. 17, 2023, which is hereby incorporated by reference in its entirety.

### SUMMARY

The technical context of the present invention is the electrical batteries, notably batteries with strong electrical current, notably higher than 50 A, and preferably higher than 500 A, for example for aeronautics and/or aerospace.

A battery usually comprises several modules or battery cells that constitute a set, which can be further linked to an external bus to allow the upload of data to a supervision system, said system being generally called battery management system.

In particular, the battery management system is configured to measure various physical values relative to the battery and to the battery modules, such as voltage values, current values, temperatures, internal resistances, etc., but also comprises protective circuits to prevent the battery from working in abnormal operating conditions, conditions that may damage the battery and be harmful to people and/or materials.

By abnormal operating conditions, it shall generally be understood: overvoltage, overcurrent, undervoltage, too high temperature of the battery, short circuits, etc. which means all the parameters that do not match a nominal operating range of the battery.

So, battery management systems comprise security devices, such as a circuit breaker configured to disconnect the battery from the outside (hence to electrically isolate it) in the case where abnormal operating conditions may happen.

Such circuit breakers are generally monitored by a monitoring circuit that takes part in the management system, which monitors the values of some electrical parameters, for example the voltage at the terminals of the battery, and which trips the circuit breaker if these electrical parameters have values of abnormal operating conditions.

A battery, for example lithium-ion, designed for aeronautics and/or aerospace, can feature voltages from a few dozen volts to more than a thousand volts, with discharge currents between a dozen and a hundred amperes.

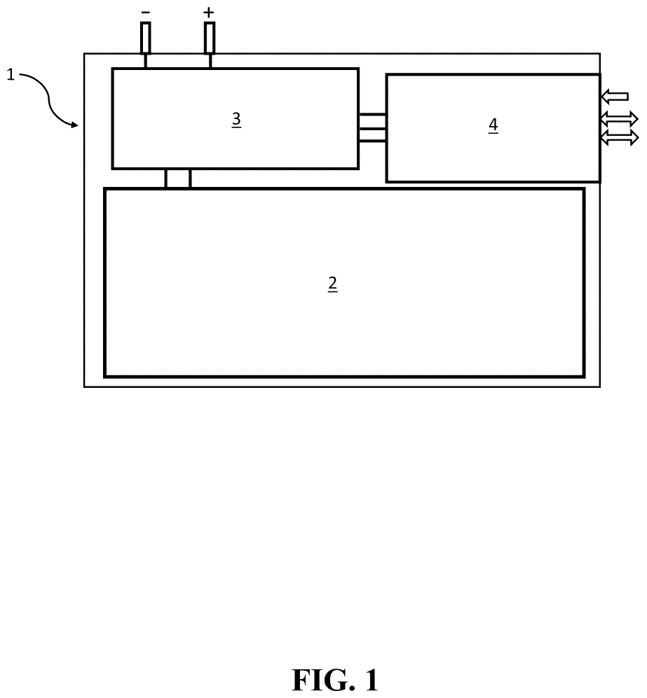

Of course, such batteries comprise several cells or accumulators and are laid out serially connected or in parallel. For example, there can be 8 3.3-volt cells serially connected as pictured in [FIG. 1]. The sum of this series of cells generates a global voltage of ca. 26.4 V.

Thus, during the reloading of these batteries, in particular of the battery cells, it is necessary to feed them with a preset current, for example 5 A, the time required for the total reloading of said battery cells. This reloading process is generally made thanks to a device or circuit that makes it possible to regulate the load current delivered to the battery to load.

Unfortunately, the devices or circuits of the art feature electrical components, whose temperature increase (or overheating) leads to a variation of the load current, whose value is more than an allowable value and/or a battery protection value. In addition, the devices or circuits of the art can also feature overcurrents relative to the load current at the launching of the battery loading (for example several dozen amperes for 2 seconds) and/or feature an average load current value far less than a desired target value.

The present invention aims at remedying at least one of the above-mentioned drawbacks with a new type of regulation of a charge current for a battery, said device being a quadrupole configured to link a battery to charge to a charging device,

said device comprising at least a first transistor, said charge transistor, and a thermistor, which are configured to regulate, in association, the charge current of the battery according to the temperature.

The present regulation device for the charge current for the loading of the battery or of at least one battery cell, is a cheap, robust solution, easy to integrate to a battery management system, while allowing a better regulation and/or stability of this charge current in temperature, in particular of the temperature increase of the charge transistor.

According to a possible characteristic, said first transistor is configured to work in linear regime.

Using the charge transistor in linear regime notably makes it possible to improve the control (or the regulation) of the charge current value, in particular because the heat generated by the transistor associated with a thermistor allows a self-regulation.

According to another possible characteristic, the thermistor is thermally coupled to the first transistor.

Advantageously, the track to which the first transistor is welded is thermally coupled to the thermistor to be heated thanks to the track.

According to another possible characteristic, said device comprises a second transistor, called regulation transistor, the second transistor being configured to force a linear regime to the first transistor.

Advantageously, the regulation transistor takes part in the regulation of the voltage at the terminals of the charge transistor to maintain it in a linear operational regime.

According to another possible characteristic, the first transistor is a field effect transistor and the second transistor is a NPN-type transistor.

According to another possible characteristic, said charge transistor features a grid, a drain and a source, said grid being configured to be connected to the positive terminal of the charging device and to the positive terminal of the battery to charge, said drain being configured to be connected to the negative terminal of the charging device.

The source of the charge transistor is advantageously configured to be connected to the negative terminal of the battery to charge.

According to another possible characteristic, the grid of the transistor is configured to be connected to the positive terminal of the charging device through at least a diode and/or a resistor.

According to another possible characteristic, the regulation transistor features a base, an emitter and a collector, the collector of the regulation transistor being connected to the grid of the charge transistor, the base of the regulation transistor being connected to the source of the charge transistor.

According to another possible characteristic, the regulation transistor is mounted parallel to the charge transistor, which means that the base and the collector of the regulation transistor are mounted parallel to the source and the grid of the charge transistor.

According to another possible characteristic, the base of the regulation transistor is connected to the source of the charge transistor through a resistor called third resistor.

According to another possible characteristic, the device comprises a diode, called second diode, wherein the first and the second diodes are mounted as a diode dividing bridge.

The association of the first and second diodes makes it possible to close the circuit when the charging device has a voltage lower than the sum of the voltages of the first and second diodes, or when there is no connected charging device, which restricts the electrical consumption of the device when it is not used.

According to another possible characteristic, the device comprises a resistor, called second resistor, wherein the thermistor and the second resistor are mounted as a resistive dividing bridge.

The resistive dividing bridge makes it possible to regulate the current of the charge transistor as a function of the temperature (of said transistor). In addition, the second resistor makes it possible, among other things, to get a zero voltage at the grid of the charge transistor when the circuit is in gate-off state.

According to another possible characteristic, the second diode and the second resistor are mounted parallel to each other but also parallel to the charge transistor and/or to the regulation transistor.

According to another possible characteristic, the second diode is connected to the source and to the grid of the charge transistor and/or connected to the collector and to the base of the regulation transistor.

According to another possible characteristic, the base and the emitter of the regulation transistor and the source of the charge transistor are configured to be connected to the negative terminal of the battery to charge.

According to another possible characteristic, the base of the regulation transistor and the source of the charge transistor are configured to be connected to the negative terminal of the battery to charge through a resistor called fourth resistor.

The fourth resistor makes it notably possible to limit the maximal value of the charge current.

According to another possible characteristic, said thermistor is of negative temperature coefficient type.

The invention also relates to a battery management system, characterized in that said management system comprises a monitoring circuit as described above.

The invention further relates to electrical battery, characterized in that said battery comprises a management system for the battery accumulators as described above.

Other characteristics and advantages of the invention will appear thanks to the following description, on one hand, and thanks to several embodiments produced as a guide and non-limitative with a reference to the appended schematic pictures, on the other hand, where:

the [FIG. 1] shows a very schematic and functional view of an electrical battery equipped with a battery management system according to the invention;

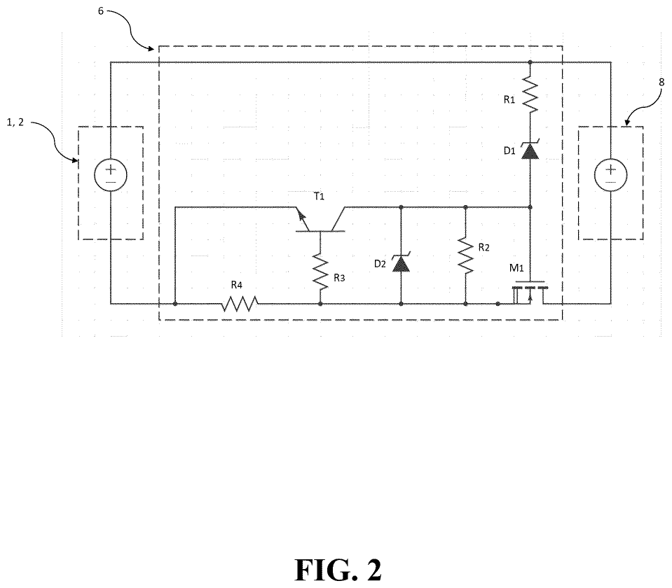

the [FIG. 2] shows a schematic view of the regulation device for a battery charge current for a management system of [FIG. 1].

Of course, the characteristics, the variants and the various embodiments of the invention can be associated under various combinations, as far as they are not mutually incompatible or exclusive. Other variants of the invention are conceivable, which only include a selection of characteristics as described below, apart from the other described characteristics, as far as this selection of characteristics is enough to give a technical advantage or to distinguish the invention from the previous state of the art.

In particular, all described variants and embodiments can be associated if it is technically possible. On the figures, common items to several figures keep the same reference.

The [FIG. 1] shows a very schematic and functional view of an electrical battery 1, for example a lithium-ion battery, advantageously designed to aeronautics or aerospace, which comprises accumulators 2, or battery cells, a management system 3 for the cells linked to said battery accumulators 2, or cells, a system 3 also called BMS for Battery Management System, and a communication circuit 4 linked to said management system 3 and configured to exchange information with the outside (information relative to the environment, to the battery, to the plane, etc.)

Said management system 3 is generally integrated to said battery 1 in order to monitor the various physical or electrical values characteristic of a battery 1 and/or of its accumulators 2, for example a voltage, an internal resistance, etc.

Said management system 3 is also configured to prevent the function of the battery 1 out of its nominal operating range, which means that the system is configured to detect abnormal operating conditions of the battery (or of its modules), such as an overcurrent, an overvoltage (in particular during its loading), an undervoltage (in particular during its unloading), an overheating, etc.

Such a system 3 can also comprise other circuits and/or devices, in particular to regulate the charge current to a battery or to one or several cells.

The [FIG. 2] shows a very schematic and functional view of a regulation device 6 of a charge current for at least one battery cell 2, said device 6 being a quadrupole configured to link the at least one battery cell 2 to load onto a charging device 8, such as an alternator, another battery, a charger, etc.

Thus, said device 6 is connected to the terminals of the at least one battery cell 2 (or accumulators) on one hand, to the terminals of the charging device 8 on the other hand. In addition, the device 6 comprises at least:
at least one transistor M₁, called charge transistor, configured to work in linear regime, said charge transistor M₁ being, for example, a field effect transistor;
a thermistor R₁ configured to regulate, in association with the charge transistor M₁, the charge current through the charge device 8 to the at least one battery cell 2 according to the temperature.

The thermistor R₁ is advantageously a thermistor of negative temperature coefficient type and is thermically coupled with the charge transistor M₁, thus the thermistor R₁ features a decrease of its resistance when the temperature of the charge transistor M₁ increases, which makes it possible to restrict, possibly to cancel, the reduction of the charge current with the increase of the temperature of said transistor M₁.

Said device 6 advantageously comprises another transistor T₁, said regulation transistor that is a transistor configured to force a linear regime to the first transistor M₁. For example, the regulation transistor T₁ is a NPN (bipolar) transistor.

Said charge transistor M₁ features a grid, a drain and a source, said grid being configured to be connected to the positive terminal of the charging device 8 and to the positive terminal of the cell 2 to charge, said drain being configured to be connected to the negative terminal of the charging device 8 while said source is connected to the negative terminal of the cell 2 to charge.

Furthermore, the device 6 comprises a diode D₁, called first diode. Thus, the grid of the charge transistor M₁ is connected to the positive terminal of the charging device 8 through the first diode D₁ and of the thermistor R₁.

The drain of the charge transistor M₁ is advantageously connected directly to the negative terminal of the charging device 8, which means that no component (resistor, diode, etc.) is inserted between the drain and said negative terminal of said charging device 8.

Thus, the device 1 comprises a branch with the thermistor R₁, the diode D₁ and the charge transistor M₁ serially mounted on it, this branch being connected in parallel to the charging device 8 (advantageously directly, which means without inserted components between said branch and the terminals of said charging device).

Furthermore, the regulation transistor T₁ features a base, an emitter and a collector, the collector of the regulation transistor T₁ being connected to the grid of the charge transistor M₁, the base of the regulation transistor T₁ being connected to the source of the charge transistor M₁. Thus, the regulation transistor T₁ is mounted parallel to the charge transistor M₁, respectively to the grid collector and source base.

So, the regulation transistor T₁ takes part in the regulation of the voltage at the grid-source terminals of the charge transistor M₁ to maintain it in a linear operational regime.

In addition, the base and the emitter of the regulation transistor T₁ and the source of the charge transistor M₁ are configured to be connected to the negative terminal of the cell 2 to charge.

Furthermore, advantageously, the device 6 comprises:
a diode D₂, called second diode, connected to the source and to the grid of the charge transistor M₁ and connected to the collector and to the base of the regulation transistor T₁;
a resistor R₂, called second resistor, connected to the source and to the grid of the charge transistor M₁ and connected to the collector and to the base of the regulation transistor T₁ (the second resistor R₂ making it possible, among other things, to get a zero voltage at the grid of the transistor M₁ when the circuit is in gate-off state);
a resistor R₃, called third resistance, wherein the base of the regulation transistor T₁ is connected to the source of the charge transistor M₁ through said third resistor R₃;
a resistor R₄, called fourth resistor, wherein the base of the regulation transistor T₁ and the source of the charge transistor M₁ are configured to be connected to the negative terminal of the cell 2 to charge through the fourth resistor R₄, the fourth resistor R₄ making it possible notably to adjust the grid potential of the charge transistor M₁, hence the self-regulation around the linear voltage of the charge transistor M₁.

Furthermore, it shall be noted that the first and second diodes D₁ and D₂ constitute a diode dividing bridge, and that the first thermistor R₁ and the second resistor R₂ constitute a resistive dividing bridge, whose resistance R₁ makes it possible to regulate the current through the charge transistor M₁ as a function of the temperature of said transistor M₁.

It shall be further noted that the terminals of the fourth resistor R₄ are connected respectively to the emitter of the regulation transistor T₁ (a terminal of the resistor that is connected to the negative terminal of the cell 2 too) and, through the third resistor R₃, to the base of the regulation transistor T₁.

Thus, the second diode D₂ and the second resistor R₂ are mounted parallel to each other but also parallel to the charge transistor M₁ and to the regulation transistor T₁.

It shall further be noted that the first and second diodes D₁ and D₂ are advantageously Zener diodes. Thus, the anode of the first diode D₁ is connected to the grid of the charge transistor M₁ while the cathode of the first diode D₁ is connected to the first resistor R₁.

Furthermore, the anode of the second diode D₂ is connected to the source of the charge transistor M₁ and to the base of the regulation transistor T₁ (in particular through the third resistor R₃) while the cathode of the second diode D₂ is connected to the grid of the charge transistor M₁ and to the collector of the regulation resistor T₁.

So, the collector of the regulation transistor T₁, the cathode of the diode D₂ and one of the terminals of the second resistor R₂ (with the other terminal of the second resistor connected to the source of the charge transistor), the anode of the first diode D₁ and the grid of the charge transistor M₁ are connected together at a common node.

So, the base of the regulation transistor T₁ (through the third resistor), the anode of the second diode D₂, the other terminal of the second resistor R₂ one of the terminals of the fourth resistor R₄ and the source of the charge transistor M₁ are connected together at another common node.

The second diode D₂ further makes it possible to limit the voltage at the terminals of the charge transistor M₁, notably the voltage between the source and the grid of said charge transistor M₁.

In addition, the association of the first and second diodes D₁ and D₂ makes it possible to close the circuit when the charging device 8 has a voltage lower than the sum of the voltages of the first and second diodes D₁ and D₂, or when there is no charging device 8 connected, thus limiting the electrical consumption of the device 6 when it is not used.

In non-pictured variants of embodiment of the invention, the regulation device 6 comprises:
an optocoupler, on one hand connected to the drain of the charge transistor M₁ and, on the other hand, designed to be connected to the negative terminal of the charging device 8, and/or
a circuit breaker, such as a switch, a disjunction means, a bistable relay, etc. on one hand, connected to the first resistor R₁ and, on the other hand, designed to be connected to the positive terminal of the charging device 8.

Thus, said optocoupler and/or circuit breaker are configured to switch off the charge of the battery in case of abnormal voltage, current, temperature, etc. by opening the circuit between the charging device 8 and the regulation device 6.

What is claimed is:

1. A device to regulate a charge current for a battery, wherein said device is a quadrupole configured to link a battery to a charging device,
said device comprising at least a first transistor (M₁), said charge transistor, and a thermistor (R₁), which are configured to regulate, in association, the charge current of the battery according to the temperature.

2. A device according to claim 1, characterized in that said first transistor (M₁) is configured to work in linear regime.

3. A device according to claim 2, characterized in that said device comprises a second transistor (T₁), called regulation transistor, the second transistor (T₁) being configured to force a linear regime to the first transistor (M₁).

4. A device according to claim 1, characterized in that said charge transistor (M₁) features a grid, a drain and a source, said grid being configured to be connected to the positive terminal of the charging device and to the positive terminal of the battery to charge, said drain being configured to be connected to the negative terminal of the charging device.

5. A device according to claim 4, characterized in that the grid of the charge transistor (M₁) is configured to be connected to the positive terminal of the charging device through the thermistor (R₁) and at least one diode (D₁).

6. A device according to claim 5, characterized in that the regulation transistor (T₁) features a base, an emitter and a collector, the collector of the regulation transistor (T₁) being connected to the grid of the charge transistor (M₁), the base of the regulation transistor (T₁) being connected to the source of the charge transistor (M₁).

7. A device according to claim 6, characterized in that the base of the regulation transistor (T₁) is connected to the source of the charge transistor (M₁) through a resistor (R₃) called third resistor.

8. A device according to claim 7, characterized in that the base and the emitter of the regulation transistor (T₁) and the source of the charge transistor (M₁) are configured to be connected to the negative terminal of the battery to charge.

9. A device according to claim 8, characterized in that the base of the regulation transistor (T₁) and the source of the charge transistor (M₁) are configured to be connected to the negative terminal of the battery to charge through a resistor (R₄) called fourth resistor.

10. A device according to claim 5, characterized in that the device comprises a resistor (R₂), called second resistor, the thermistor (R₁) and the second resistor (R₂) being mounted as a resistive dividing bridge.

11. A device according to claim 5, characterized in that the device comprises a diode (D₂), called second diode, the first (D₁) and second (D₂) diodes being mounted as a diode dividing bridge.

12. A device according to claim 1, characterized in that said thermistor (R₁) is of negative temperature coefficient type.

13. A system to manage battery accumulators, characterized in that said management system comprises a regulation device according to claim 1.

14. An electrical battery, characterized in that said battery comprises a management system for the battery accumulators according to claim 13.
